(19) United States
(12) Patent Application Publication
(10) Pub. No.: US 2005/0050816 A1
(43) Pub. Date: Mar. 10, 2005

(54) Forcible entry door simulator

(76) Inventors: Gregory E. Manning, Brooklyn, NY (US); James C. Davidson, Cedar Knolls, NJ (US); Jonathan D. Prachthauser, Morristown, NJ (US)

Correspondence Address: POLSTER, LIEDER, WOODRUFF & LUCCHESI, 12412 POWERSCOURT DRIVE SUITE 200, ST. LOUIS, MO, 63131-3615, US

(21) Appl. No.: 10/657,638

(22) Filed: Sep. 8, 2003

(51) Int. Cl. E06B 1/04

(52) U.S. Cl. 52/213

(57) ABSTRACT

A portable forced door entry training apparatus configurable to simulate a wide variety of locked or barricaded door entry conditions, and which can be utilized in conjunction with a wide variety of convention forced-entry tools for repeated forced entry training purposes. The training apparatus consists of a base plate, upon which is secured a rigid upright door frame structure having a pair of vertical side jambs, coupled at the top by a header. A conventional door is secured within the rigid frame structure by two or more hinge brackets affixed to a side jamb member of the rigid frame structure. One or more holding brackets are affixed to the rigid frame structure on the opposite side jamb member. Each holding bracket is affixed to the rigid frame structure with a replaceable frangible connection, and is positioned to resist opening of the door about the pivot axis of the hinge brackets.

### CROSS-REFERENCE TO RELATED APPLICATIONS

Not Applicable.

### STATEMENT REGARDING FEDERALLY SPONSORED RESEARCH

Not Applicable.

### BACKGROUND OF THE INVENTION

The present invention relates to training apparatus and simulators used by law enforcement, emergency medical response, or firefighting personnel, and in particular, to a portable forced door entry training apparatus which is configurable to simulate a variety of forced door entry conditions which may be encountered by such personnel.

In many emergency or law enforcement situations, it is necessary for responding personnel, such as firefighters or EMS crews, to gain access to the interior spaces of a building or structure in a rapid and efficient manner. For example, a firefighter might need to access the interior spaces of a burning structure to first ensure that no individuals are trapped inside, and secondarily, to facilitate extinguishing the fire. Similarly, law enforcement personnel may need to access the interior spaces of a structure during the execution of a search warrant or during the pursuit of a felon. Often, responding personnel are blocked from accessing some of all interior spaces of structures by locked doors.

A wide variety of techniques and tools are commonly utilized for “force” or open locked doors during structure entry. The specific techniques and tools utilized are dependant upon a number of conditions, including the type of door which is being forced, i.e., a steel-reinforced entry door or a fiberboard interior door, and upon the type of hardware supporting and securing the door. Tools which are commonly utilized to force entry through locked doors include rams, crowbars, and specialized “Haligan” tools. Each type of tool utilized is most efficient if used correctly against the locked door or associated door hardware.

Accordingly, it would be advantageous to provide a forced door entry training apparatus which may be configured to simulate a wide variety of locked or barricaded door conditions, and which can be utilized in conjunction with a wide variety of convention forced-entry tools for repeated training purposes.

### BRIEF SUMMARY OF THE INVENTION

Briefly stated, the present invention provides a portable forced door entry training apparatus which may be configured to simulate a wide variety of locked or barricaded door conditions, and which can be utilized in conjunction with a wide variety of convention forced-entry tools for repeated training purposes. The training apparatus consists of a base plate, upon which is secured a rigid upright door frame structure having a pair of vertical side jambs, coupled at the top by a header. A conventional door is secured within the rigid frame structure by two or more hinge brackets affixed to a side jamb member of the rigid frame structure. One or more holding brackets are affixed to the rigid frame structure on the opposite side jamb member. Each holding bracket is affixed to the rigid frame structure with a frangible connection, and is positioned to resist opening of the door about the pivot axis of the hinge brackets.

A method of the present invention for simulating a forced door entry in an assembled portable door frame structure includes the steps of securing a door to a pair of hinge brackets using frangible connectors. The door is positioned in the closed configuration within the portable door frame structure, and at least one holding bracket is secured to the portable door frame structure on an opposite member from the hinge brackets. Each holding bracket is secured to the portable door frame structure with frangible connectors, and overlaps a portion of the door face. Additional frangible connectors secure the door face to the holding bracket. To simulate the forced door entry, the door is approached from the side opposite the hinge brackets and holding brackets. An entry tool is inserted between the door and the door frame structure, approximately level with either one of the holding brackets or hinges, and a leverage force applied thereto to sever one or more of the frangible connectors, freeing the door to open. Upon replacement of the frangible connectors, and door if required, the process may be repeated indefinitely.

The foregoing and other objects, features, and advantages of the invention as well as presently preferred embodiments thereof will become more apparent from the reading of the following description in connection with the accompanying drawings.

### BRIEF DESCRIPTION OF THE SEVERAL VIEWS OF THE DRAWINGS

In the accompanying drawings which form part of the specification:

FIG. 1 is a perspective view of the forced door entry training apparatus of the present invention;

FIG. 2 is a front view of the forced door entry training apparatus of FIG. 1;

FIG. 3 is a top view of the forced door entry training apparatus of FIG. 1; and

FIG. 4 is a side view of the forced door entry training apparatus of FIG. 1;

FIG. 5 is a partial perspective view of a hinge bracket of the present invention secured to a door;

FIG. 6 is a partial perspective view of a holding bracket of the present invention preventing opening of a door; and

FIG. 7 is a partial perspective view of alternate connectors utilized with the present invention to secure a door.

Corresponding reference numerals indicate corresponding parts throughout the several figures of the drawings.

### DESCRIPTION OF THE PREFERRED EMBODIMENT

The following detailed description illustrates the invention by way of example and not by way of limitation. The description clearly enables one skilled in the art to make and use the invention, describes several embodiments, adaptations, variations, alternatives, and uses of the invention, including what is presently believed to be the best mode of carrying out the invention.

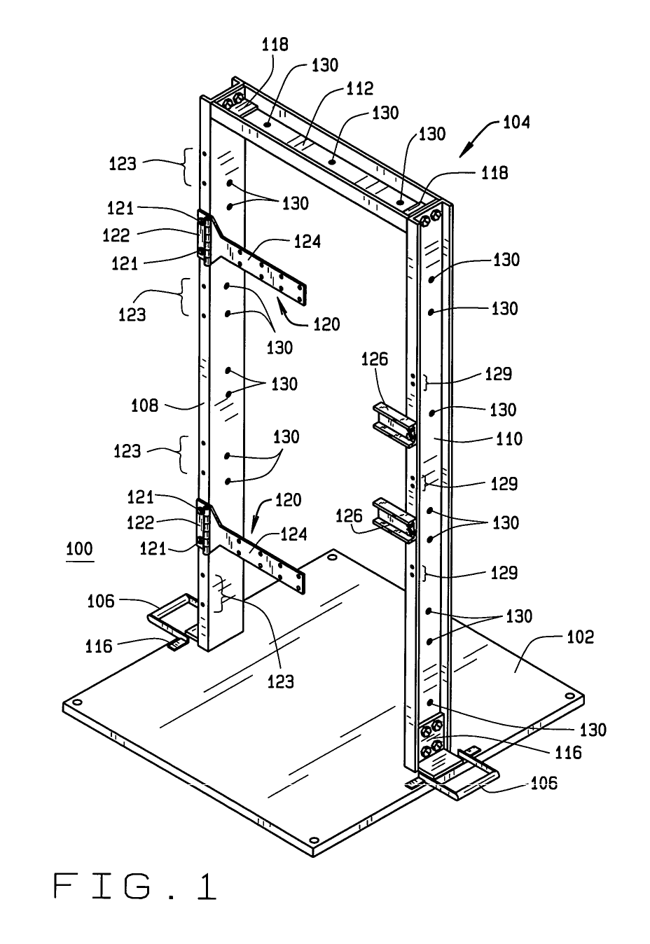

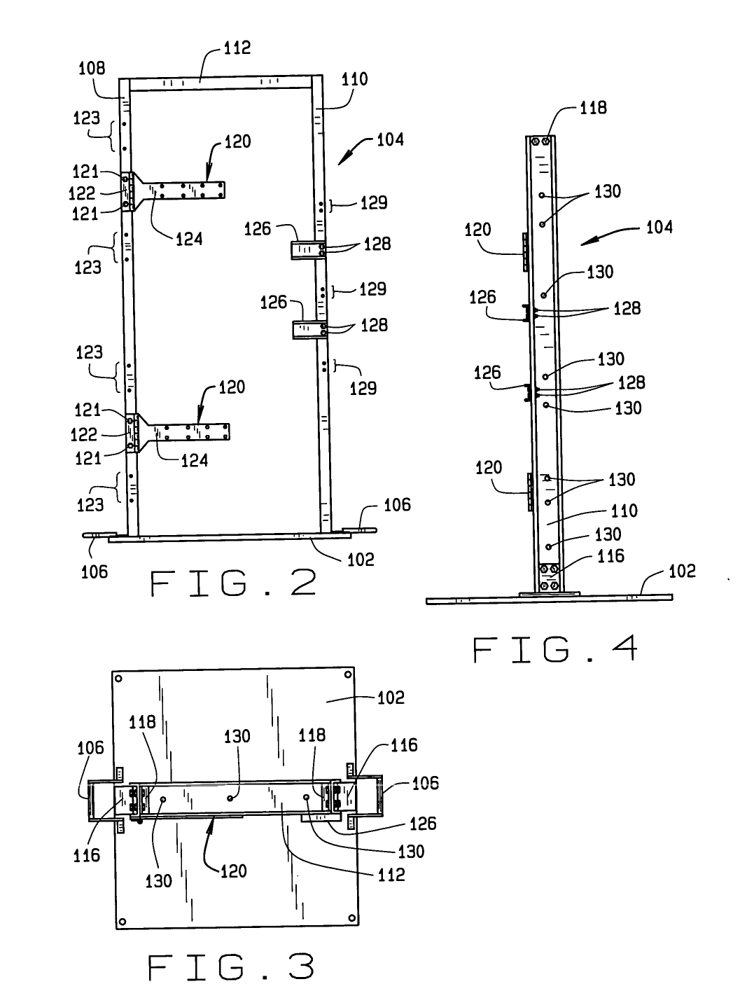

Turning to FIG. 1 through FIG. 4, a preferred embodiment of the forcible door entry training simulator of the present invention is shown generally at 100. The training simulator 100 comprises a base plate 102, and a door frame 104 secured to the base plate 102. The base plate 102 is preferably constructed from a heavy gauge steel or metal, and has sufficient weight and dimensions to prevent tipping of the door frame 104 when forces are exerted against it during a forcible door entry training simulation, yet remains portable without mechanical assistance. Optionally, handles 106 may be secured about the edges of the base plate 102 to facilitate lifting and transportation.

The door frame 104 consists of three components, a left vertical jamb 108, a right vertical jamb, 110, and a header 112. Each vertical jamb 108, 110 is removably secured to the base plate 102 in an upright configuration and spaced apart to receive a conventional door 114 there between. Preferably, an angle bracket 116 is bolted to the base plate 102 and to each of the vertical jambs 108, 110 to provide attachment and support. The header 112 is secured between the top edges of the vertical jambs 108, 110, defining a standard height door opening. The header 112 may either be permanently secured to the top edges of the vertical jambs 108, 110, such as by welding or other suitable attachment means, or may be removably secured with a pair of angle brackets 118 and removable bolts, thereby facilitating disassembly and transport of the forcible door entry training simulator 100.

Preferably, each of the vertical jambs 108, 110, and the header 112 is a unitary segment of channel steel, of sufficient gauge to withstand repeated stresses from forces exerted against it during a forcible door entry training simulation. Each of the angle brackets 116, 118 is similarly constructed from a suitable gauge metal. Those of ordinary skill in the art will recognize that any of a variety of materials may be utilized in the construction of the door frame 104, provided that sufficient strength is maintained to withstand repeated stresses from forces exerted against the door frame 104 during a forcible door entry training simulation, and provided that the weight of the individual components 108, 110, and 112 is sufficient to prevent transportation or to unbalance the forcible door entry training simulator 100 when assembled.

To secure the conventional door 114 to the door frame 104, at least one hinge bracket 120 is secured to one of the vertical jambs 108, 110 by removable bolts 121. Preferably, a pair of hinge brackets 120 are utilized, displaced vertically from each other and positioned approximately at conventional door hinge heights on the associated vertical jamb, however, those of ordinary skill in the art will recognize that the door hinge bracket may be in the form of a single elongated piano-type hinge, or that more than two hinge brackets may be utilized. To facilitate placement of the hinge brackets 120 in alternate locations, additional receiving locations 123 are provided for the bolts 121 in the frame members. The hinge brackets 120 are preferably formed from metal of sufficient gauge to withstand repeated stresses from forces exerted against them during a forcible door entry training simulation. The selection of the number and type of hinge brackets 120 utilized may be varied depending upon the type of forcible door entry simulation desired.

Preferably, as shown in FIG. 5, each hinge bracket 120 consists of a jamb plate 122, which is secured to the associated jamb, and a door plate 124, which is removably secured to a face of the conventional door 114 by removable connectors 125. Alternatively, the door plate 124 may be removably secured to an edge of the standard door 114 by the removable connectors 125. The jamb plate 122 and hinge plate 124 for each hinge bracket 120 are coupled via a pivoting connection to form a conventional hinge coupling.

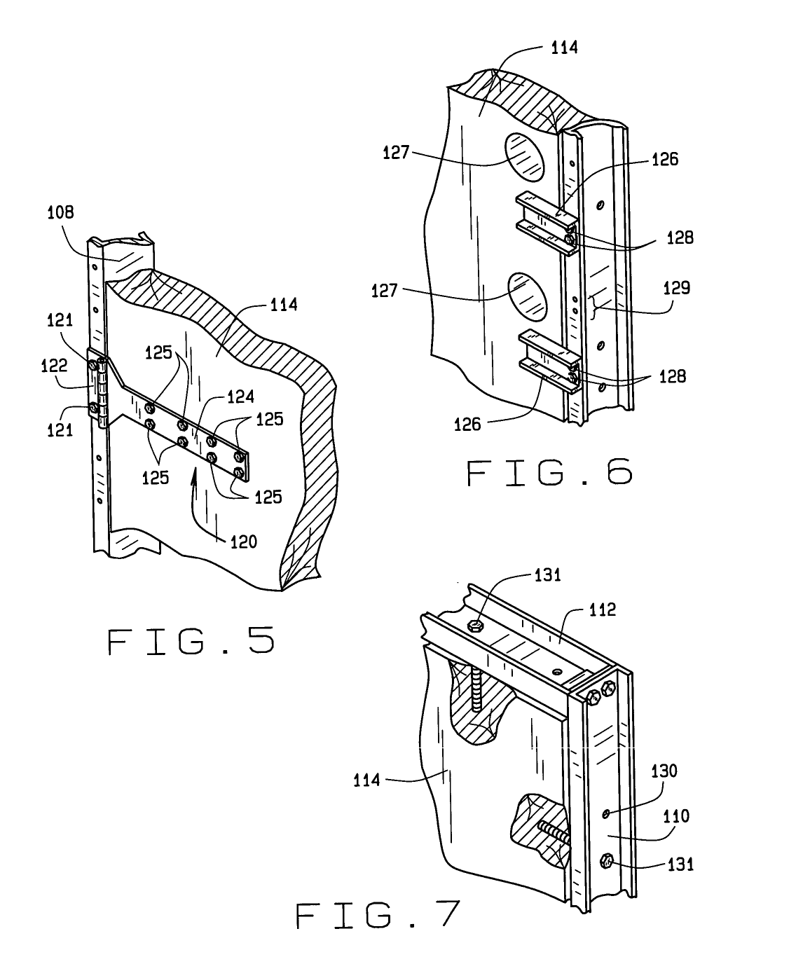

On the opposite jamb from the hinge brackets 120, one or more holding brackets 126 are removably secured to the respective jamb with one or more frangible connectors 128. Preferably, as best seen in FIG. 6, at least two holding brackets are secured to the respective jamb in a vertically spaced relationship approximately corresponding to the vertical locations of a door knob and/or deadbolt lockset bores 127. Each holding bracket 126 is preferably constructed from metal of sufficient gauge to withstand repeated stresses from forces exerted against them during a forcible door entry training simulation. Each holding bracket 126 extends past the inner edge of the respective jamb, blocking the conventional door 114 from opening about the hinge couplings provided by the hinge brackets 120 unless sufficient force is exerted to break the frangible connectors 128 or the door 114. Preferably, the frangible connectors 128 have predetermined holding strength which permits each holding bracket 126 to resist opening of the door 114 with approximately the same force as a conventional door knob or deadbolt lock mechanism.

Those of ordinary skill in the art will recognize that the number and placement of the holding brackets 126 may be varied to simulate a variety of forcible door entry conditions, ranging from a single standard locked doorknob to a locked security door having multiple locking points. To facilitate placement at different locations about the door frame 104, multiple sets of connector receiving locations 129 are provided in the frame members. Furthermore, the placement of the holding brackets 126 is not limited to the jamb opposite the hinge brackets 120, and may include the header 112 or the same jamb on which the hinge brackets 120 are placed, simulating doors locked at the top edge, or having cross-face locking mechanisms.

During use, it is intended that the base plate 102, the door frame 104, the hinge brackets 120, and the holding brackets 126 be reused for each forcible door entry training simulation. However, it is intended that the frangible connectors 128 be replaced after each use, and that the conventional door 114 be a consumable product to be replaced as required due to damage suffered during a forcible door entry training simulation. Those of ordinary skill in the art will recognize that since the conventional door 114 is not held in the door frame 104 with conventional hardware in the knob or lockset bores 127, it may be reversed and/or inverted during attachment to the hinge brackets 120 as required to provide new attachment points for the hinge brackets 120 as required.

Optionally, either the removable bolts 121 or removable connectors 125 utilized to secure the hinge brackets 120 to the respective jamb and door surface may be replaced with frangible connectors having a predetermined holding strength, permitting a simulation of the forces required to forcibly detach the conventional door 114 from a hinge or frame during a forcible entry.

In a further option, shown in FIG. 7, each of the vertical jambs 108, 110, and header 112 may include one or more openings 130 through an inner surface, aligned with one or more perimeter edges of the conventional door 114 when it is in a closed position within the door frame 104. One or more removable bolts, screws, or frangible connectors 131 may optionally be passed through these openings 130 and engaged with the perimeter edges of the conventional door 114 to provide additional holding forces between the door frame 104 and conventional door 114 against which a forcible door entry may be simulated. It will be understood by those of ordinary skill in the art that if removable bolts or screws are utilized, the conventional door 114 will break during the forcible entry simulation. Alternatively, if frangible connectors are utilized, the conventional door 114 will be more likely to remain intact during the forcible entry simulation, permitting reuse during a subsequent simulation after replacement of any broken frangible connectors.

During use, the forcible door entry training simulator 100 is transported in a disassembled manner to the location at which it will be used. Initially, the base plate 102 is placed in the intended location, and the door frame 104 secured thereto using the angle brackets 116. If not previously assembled, the header 112 is secured to the left and right vertical jambs 108, 110. Next, the number and location of the hinge brackets 120 is selected, based upon the desired forcible door entry simulation. Each of the selected hinge brackets 120 is then secured to a selected vertical jamb at a jamb bracket with either removable bolts or frangible connectors. Correspondingly, a standard door 114 is secured to the door plates 124 of the hinge brackets with either removable bolts or frangible connectors.

With the standard door 114 in a closed configuration with the door frame 104, the number and location of the holding brackets 124 is selected, based upon the desired forcible door entry simulation. Each of the selected holding brackets 124 is then secured to a selected vertical jamb 108, 110, or the header 112, with one or more frangible connectors. Optionally, to further increase the holding force securing the standard door 114 within the door frame 104, one or more removable bolts, screws, or frangible connectors are passed through openings in the inner surface of the door frame 104 to engage a perimeter edge of the standard door 114.

Those of ordinary skill in the art will recognize that the selection and placement of the removable bolts and frangible connectors used to secure the standard door 114 within the door frame 104, or to hold either the hinge brackets 120 or holding brackets 124 in place is dependant upon the desired characteristics of the forcible entry simulation. At one extreme, a minimal number of frangible connectors is utilized, permitting the standard door 114 to be forcibly opened upon the exertion of a minimal force. At the other extreme, a large number of either frangible connectors or removable bolts is utilized, resulting in the need for a significantly greater force to open the standard door 114 within the frame 104. It is entirely possible that the selected connectors and placement of the holding brackets 104 results in a configuration wherein it is necessary to damage or destroy the standard door 114 during the forcible entry simulation. Accordingly, it is intended that the standard door 114 be a consumable item in the context of the present invention.

Once the forcible door entry training simulator 100 is assembled with a standard door 114 in place, the simulator is ready for personnel practicing a forcible door entry. Forcible door entries which may be simulated on the training simulator 100 include entries with the use of rams, pry bars, Haligan tools, and non-conventional techniques. The placement and location of the frangible connectors are selected to provide a simulated resistance to opening of the door 114 with the frame 104 which corresponds approximately to the resistance encountered in an emergency situation. The frangible connectors are intended to break or detach from the door 114 and vertical jambs 108, 110 upon correct application of a sufficient force, thereby simulating forced entry through a locked door.

Upon completion of a forcible entry training simulation, the standard door 114 is returned to the closed configuration within the door frame 104, and any broken frangible connectors replaced, resetting the training simulator 100 for a subsequent simulation. If the door 114 is damaged and an adequate attachment to either the hinge brackets 120 or door frame 104 is not possible, the standard door 114 may be inverted and/or reversed to provide expose new attachment points. Alternatively, if the standard door 114 is sufficiently damaged, it is replaced.

In view of the above, it will be seen that the several objects of the invention are achieved and other advantageous results are obtained. As various changes could be made in the above constructions without departing from the scope of the invention, it is intended that all matter contained in the above description or shown in the accompanying drawings shall be interpreted as illustrative and not in a limiting sense.

1. A forced door entry training apparatus including:
a base plate;
a rigid door frame secured to said base plate, said rigid door frame consisting of a left vertical jamb, a right vertical jamb, and a header coupled between a top of said left and right vertical jambs, said rigid door frame having a front face and a rear face;
one or more hinge brackets secured to one of said left and right vertical jambs on a rear face of said rigid door frame;
one or more holding brackets secured to a second of said left and right vertical jambs on said rear face of said rigid door frame; and
a standard door secured within said rigid door frame by said hinge brackets, said door restricted from rearward opening by said one or more holding brackets.

2. The forced door entry training apparatus of claim 1 wherein said one or more hinge brackets are secured to said vertical jamb by at least one frangible connector.

3. The forced door entry training apparatus of claim 1 wherein said one or more hinge brackets are secured to said door by at least one frangible connector.

4. The forced door entry training apparatus of claim 1 wherein said one or more holding brackets are secured to said vertical jamb by at least one frangible connector.

5. The forced door entry training apparatus of claim 1 wherein said one or more holding brackets are secured to said door by at least one frangible connector.

6. The forced door entry training apparatus of claim 1 wherein at least one of said one or more holding brackets is aligned substantially with a door lockset location.

7. The forced door entry training apparatus of claim 1 wherein said door is restricted from rearward opening by said one or more holding brackets having a predetermined holding strength.

8. The forced door entry training apparatus of claim 7 wherein said predetermined holding strength is selected to approximate a door lockset holding strength.

9. The forced door entry training apparatus of claim 1 wherein said rigid door frame is secured to said base plate by a plurality of removable bolts; and
wherein said header is coupled between said top of said left and right vertical jambs by a plurality of removable bolts;
wherein said rigid door frame is detachable from said base plate and disassemble into a plurality of discrete components.

10. The forced door entry training apparatus of claim 1 further including
at least one removable attachment component coupling said rigid door frame to a perimeter edge of said standard door.

11. The forced door entry training apparatus of claim 10 wherein said at least one removable attachment component is a frangible connector.

12. A method for simulating a forced door entry through a standard door secured in a rigid door frame structure by at least one hinge bracket, and restricted from opening by at least one holding bracket including at least one frangible connector having a predetermined holding strength, comprising:
inserting a door entry tool between said door and said rigid door frame structure from a side opposite said at least one hinge bracket and said at least one holding bracket;
applying a leverage force between said door and said rigid door frame structure, said leverage force sufficient to exceed said predetermined holding strength of said at least one frangible connector;
breaking said at least one frangible connector, thereby releasing said holding member to permit opening of said door.

13. The method for simulating a forced door entry of claim 12 further including the step of selecting a vertical placement location for said at least one holding bracket prior to applying said leverage force, said vertical placement location selected to simulate one or more door locksets.

14. The method for simulating a forced door entry of claim 12 further including the step of selecting said predetermined holding strength for said at least one frangible connector prior to applying said leverage force, said holding strength selected to approximate a holding strength of one or more door locksets.

15. The method for simulating a forced door entry of claim 12 further including the step of resetting said standard door in a closed configuration subsequent to breaking said at least one frangible connector by closing said door within said rigid door frame structure and replacing said frangible connector in said at least one holding bracket.

16. The method for simulating a forced door entry of claim 12 further including the step of resetting said standard door in a closed configuration subsequent to breaking said at least one frangible connector by:
detaching said standard door from said at least one hinge bracket;
altering an orientation of said standard door;
reattaching said standard door in said altered orientation to said at least one hinge bracket; and
closing said door within said rigid door frame structure and replacing said frangible connector in said at least one holding bracket.

17. The method for simulating a forced door entry of claim 12 further including the step of resetting said standard door in a closed configuration subsequent to breaking said at least one frangible connector by:
altering a placement of said at least one holding bracket;
closing said door within said rigid door frame structure; and
replacing said frangible connector in said at least one holding bracket.

18. A forced door entry training apparatus including:
a base plate;
a rigid door frame secured to said base plate, said rigid door frame consisting of a left vertical jamb, a right vertical jamb, and a header coupled between a top of said left and right vertical jambs, said rigid door frame having a front face, a rear face, and an inner surface;
first and second hinge brackets secured to one of said left and right vertical jambs on a rear face of said rigid door frame;
first and second holding brackets secured to a second of said left and right vertical jambs on said rear face of said rigid door frame, said first holding bracket secured at a door knob height, said second holding bracket secured at a deadbolt lockset height; and
a standard door secured within said rigid door frame, adjacent said inner surface, by said first and second hinge brackets, said door restricted from rearward opening by said first and second holding brackets, said first holding bracket configured to simulate a holding strength of a conventional door knob, and said second holding bracket configured to simulate a holding strength of a convention deadbolt lockset.

19. The forced door entry training apparatus of claim 18 wherein said first and second holding brackets are configured to simulate said respective holding strengths with one or more replaceable frangible connectors.

20. The forced door entry training apparatus of claim 18 further including at least one replaceable frangible connector operatively coupling a perimeter edge of said standard door to said inner surface of said rigid door frame.
